(19) United States
(12) Patent Application Publication
(10) Pub. No.: US 2019/0320671 A1
(43) Pub. Date: Oct. 24, 2019

(54) IRRADIATION OF FOOD PRODUCTS

(71) Applicant: BNE Investments, Inc., Oakley, ID (US)

(72) Inventor: Bruce Mitchell, Oakley, ID (US)

(21) Appl. No.: 16/392,508

(22) Filed: Apr. 23, 2019

Related U.S. Application Data
(60) Provisional application No. 62/661,630, filed on Apr. 23, 2018.

(51) Int. Cl. A23B 7/015

(52) U.S. Cl. CPC A23B 7/015; A23V 2002/00

(57) ABSTRACT

A crop treatment apparatus is capable of irradiating plant products harvested from beneath the surface of the ground to prevent sprouting, regrowth, and/or decay of the plant products and/or contamination of the plant products by one or more microorganisms. The crop treatment apparatus may include shielding and a conveyor system. The conveyor system may direct the plant products past an irradiation element and then directly into storage or packaging. Embodiments of crop treatment apparatuses that are capable of treating plant products as they are harvested or prior to harvesting the plant products from the ground are also disclosed.

### CROSS-REFERENCE TO RELATED APPLICATION

A claim for priority to the Apr. 23, 2019 filing date of U.S. Provisional Patent Application No. 62/661,630, titled MOBILE IRRADIATION APPARATUSES AND METHODS FOR IRRADIATING FOOD PRODUCTS (“the '630 Provisional Application”), is hereby made pursuant to 35 U.S.C. § 119(e). The entire disclosure of the '630 Provisional Application is hereby incorporated herein.

### TECHNICAL FIELD

This disclosure relates generally to methods for treating plant products. More specifically, this disclosure relates to methods of inhibiting sprouting or regrowth in plant products, such as vegetables, that grow underground, such as tubers (e.g., potatoes, yams, sweet potatoes, cassava, etc.) and root vegetables (e.g., carrots, beets, onions, garlic, etc.) while the plant products remain in the ground or while harvesting, collecting, storing, and/or removing the plant products from storage. More specifically, this disclosure relates to mobile irradiation apparatuses and methods for treating plant products with a low dose of high-speed ionizing irradiation (e.g., ionizing radiation, etc.) delivered at a high instantaneous dose rate to prevent sprouting, regrowth, and/or decay while not substantially damaging the non-meristematic cells of the plant products. This disclosure also relates to methods in which plant products are exposed to radiation (e.g., electromagnetic radiation, etc.) that will limit growth and/or proliferation of microorganisms on the plant products.

### BACKGROUND

For the purposes of this disclosure, the term “plant product” refers to vegetables and other plant products that grow underground and that tend to sprout, regrow, and/or decay following their removal from the ground.

The storage of plant products is complicated by several factors inherent to these products, including sprouting, regrowth, and decay. Because sprouting and regrowth consume some of the energy stored within the plant product, it is desirable to inhibit these processes. Similarly, if a plant product is injured, some of the energy (e.g., sugar, starch, etc.) stored in the plant product, may be consumed or converted to repair the injury. As the energy stored within a plant product is depleted, the plant product begins to decay.

As an example of the relationship between sprouting, regrowth, and decay, the storage of sugar beets will be discussed in some detail. The value of a sugar beet is directly proportional to the amount of sugar that can be extracted from that sugar beet. To prevent sugar beets from regrowing foliage during storage and, thus, from consuming the sugar they store, sugar beets are typically “crowned.” Crowning refers to cutting off a portion of the top of the root (called the “crown”) from the sugar beet. Some of the sugar stored by the sugar beet is immediately lost when the crown is removed. In addition, crowning injures the sugar beet, which then metabolizes sugar to generate the energy needed to repair the injury—a process that may be referred to as “top regrowth.” Further, the injury created by crowning provides an opening through which plant pathogens may invade the sugar beet. While sugar beets use sugar to repair themselves, they generate heat and decay. To further complicate matters, sugar beets are typically stacked atop one another in piles. Both top regrowth and decay generate heat that creates environmental conditions that further accelerate decay and regrowth in neighboring sugar beets in the pile. If crowning could be avoided, more sugar would be available for later processing providing greater returns to both the grower and the processor. Regrowth and decay may also increase the difficulty and cost of the sugar extraction process.

In many undeveloped and underdeveloped nations, including regions where adequate storage facilities and preservation processes are not available, plant products that grow underground are often left underground until they are needed. While leaving the plant products underground may reduce injury and slow decay, the plant products still decay when they are left underground.

At least two methods are currently available to inhibit sprouting in vegetables. First, herbicides, such as the chemicals chloropropham (CIPC) and malechydrazide, may be applied to plant foliage or to stored plant products. While herbicides may inhibit sprouting, they are effective for only a limited duration and must be reapplied following the expiration of that duration. Furthermore, the United States Environmental Protection Agency (EPA) and other governmental regulatory bodies regulate the use of herbicides and have restricted the amounts of herbicides that can be present on the skins or surfaces of a plant product, such as a potato.

Even where adequate storage facilities and preservation processes are available, plant products that grow underground typically sprout and/or decay within relatively short periods of time. For example, in the United States, potatoes often “green” shortly after their delivery to market. It is estimated that eighty-two percent (82%) of all produce grown in the United States is thrown away rather than consumed.

The use of ionizing radiation in the form of gamma rays and x-rays has also been known to inhibit sprouting in potatoes since the mid-1960s. The types of radiation have been used to treat plant products: high-speed electrons, x-rays, and gamma rays. The amount of ionizing radiation absorbed by the plant product is a function of the rate of exposure and the duration of the exposure. Other factors, such as the probability of energy absorption of the individual materials within the foodstuff may also affect the level of ionizing radiation absorbed by the plant product. Generally speaking, the ionizing radiation that has been used to sterilize plant products includes the delivery of high doses of ionizing radiation (approximately 25 kGy or 2500 kilorads) at high dose rates to reduce exposure times.

Smaller doses of ionizing radiation have been used to prevent cell division and, thus, regrowth and sprouting of plant products that have grown underground. The FDA has approved an absorbed dose of up to 2 kGy (or 200 kilorads) to prevent sprouting. This standard is based on a method using gamma radiation emanating from a Cobalt-60 source. The gamma radiation is typically delivered at a relatively low dose rate for a period of time sufficient to deliver a dose necessary to inhibit sprout growth. Doses of about 20 kilorads or greater are typically delivered to potatoes. It has been observed, however, that doses of approximately 20 to 25 kilorads and greater typically cause substantial damage to many of the cells of a potato. In some cases, dosages of 20 kilorads or more cause the plant to die. When an organism is damaged or killed, it may begin to decay. Therefore, the high doses of gamma radiation that are typically applied to potatoes, which are well within the FDA standard, render the potatoes vulnerable to decay.

When gamma radiation is used to irradiate plant products, the plant products are typically placed in containers and the batches of potatoes filling the containers are then exposed to the gamma radiation. The gamma radiation penetrates the entire volume of the container and all of its contents. However, batch irradiation processes are time consuming and, thus, costly. Since the cost of potatoes is low and batch irradiation processes would significantly increase their cost, batch irradiation processes are not often used to inhibit sprouting, growth, or decay in potatoes.

Using traditional radioactive sources as sources of gamma radiation and x-radiation has additional disadvantages. These systems are physically large and typically require permanent installations. In addition, it typically takes radioactive sources a long period of time, such as several hours, to deliver a sufficient dose of radiation to prevent cell division in plant products.

High-speed electrons offer an alternative to traditional radioactive sources. The use of high-speed electron irradiation to sterilize foodstuffs is well known in the art. For example, both U.S. Pat. No. 6,203,755 (“Odland”) and U.S. Pat. No. 3,779,706 (“Nablo”) disclose sterilization methods that utilize high-speed electron irradiation. Odland is directed toward sterilizing biological tissues derived from animals, while Nablo is directed toward bulk sterilization generally and toward sterilizing foodstuffs in particular. Odland teaches using an absorption dose of 25 kGy to 28 kGy and a dose rate of 7,800 Gy/min (468 kGy/hr). Nablo discloses using a dose rate of 107 rads/sec and a dosage level ranging from a few tenths to several megarads. Nablo also discloses that conventional high-speed irradiation sterilization operates at a rate of 1 Gy/sec to 1000 Gy/sec. All of these techniques deliver dosage levels much higher than is necessary to inhibit sprouting. Furthermore, at these dose levels, the cells of the plant product such as a potato or sugar beet are substantially damaged. Generally speaking, a dose of about 20 kilorads or greater delivered to a potato may result in damage to or the death of potato cells.

While high-speed electron irradiation has been used to sterilize plant products, it has not been used to inhibit sprouting or regrowth of plant products.

### SUMMARY

In various aspects, methods and apparatuses for non-chemically treating plant products that grow underground are disclosed. Treatment of a plant product may include non-chemically inhibiting sprouting of the plant product, preventing further growth of the plant product, killing or otherwise limiting the growth and/or proliferation of microorganisms on the plant product, otherwise preventing decay of the plant product, or otherwise affecting the plant product in a manner that will benefit the plant product, such as by increasing its shelf life or storage life, improving its quality (e.g., flavor, texture, etc.), or the like.

A crop treatment apparatus according to this disclosure may include one or more irradiation elements. Each irradiation element may generate a dose of radiation capable of treating the plant products. As an example, an irradiation element may generate a dose of ionizing radiation and direct it onto the plant products in a manner that will inhibit cell division of meristematic cells of plant products without damaging non-meristematic cells of the plant product. A suitable dose may range from about 2.5 kilorads to about 50 kilorads (e.g., about 20 krads, or about 0.20 kGy; about 25 krads, or about 0.25 kGy; about 50 kilorads, or about 0.050 kGy; etc.). A suitable dose rate may be about 10⁶ (one million) rads per second or greater. In some embodiments, the irradiation element of the crop treatment apparatus may include an electron accelerator capable of generating a low dose of high-speed electrons and of directing the electrons into the ground at a high dose rate. As another example, an irradiation element may generate and deliver one or more wavelengths of bandwidths (i.e., ranges of bandwidths) of electromagnetic radiation. In a specific embodiment, the irradiation element may generate and deliver ultraviolet (UV) radiation (e.g., 10 nm to 400 nm, 100 nm to 280 nm (ultraviolet C or UV-C), 200 nm to 300 nm (middle UV), about 250 nm, etc.) at an intensity that may kill or otherwise limit the growth and/or proliferation of bacteria, fungi, and other microorganisms on the skins or surfaces of the plant products, or sanitize the plant products.

The crop treatment apparatus may be capable of directing the radiation onto plant products in an unfocussed manner; i.e., over an area.

Shielding on or associated with the crop treatment apparatus may provide at least some control over the area or areas—each a field of exposure—onto which the each irradiation element of the crop treatment apparatus directs radiation. In addition, shielding of the crop treatment apparatus may limit or prevent exposure of individuals who operate the crop treatment apparatus or who are otherwise located in proximity to the crop treatment apparatus to the radiation. The shielding may be formed from one or more materials that attenuate, or limit the passage therethrough, of radiation generated and delivered by each irradiation element of the crop treatment apparatus. As an example, the shielding may comprise concrete, steel, lead (Pb), tungsten (W) or another material that attenuates the radiation generated and delivered by one or more irradiation elements of the crop treatment apparatus. A configuration of the shielding may provide for a path that enables food products to continuously move into, through, and out of the crop treatment apparatus while preventing radiation generated and delivered by at least one irradiation element from escaping the shielding. As an example, the shielding may comprise a bunker that defines a nonlinear path through the crop treatment apparatus.

The crop treatment apparatus include features that enable it to receive plant products that have been harvested from the ground, irradiate the plant products, and deliver the treated plant products. Without limitation, a conveyor system may receive the plant products, direct the plant products into and through a shielded treatment area (e.g., an area covered by lead (Pb) shielding, an area covered by tungsten (W) shielding; a concrete bunker; a steel bunker; etc.), which shielded treatment area may include a field of exposure where the plant products may be irradiated, and then transport the plant products out of the shielded treatment area. In some embodiments, the conveyor system may include at least one residency element, which may retain that the plant products within in the field of exposure of the irradiation element for a sufficient period of time to ensure that the plant products receive a sufficient dose of radiation generated and delivered by each irradiation element of the crop treatment apparatus and/or ensure that the plant products do not remain within the field of exposure long enough to receive an excessive dose of radiation generated and delivered by any irradiation element of the crop treatment apparatus.

The crop treatment apparatus may have a configuration that enables it to irradiate plant products in connection with harvesting the plant products or as part of a storage process. The conveyor system of or associated with such a crop treatment apparatus may have a configuration that enables it to receive plant products directly from harvesting equipment, convey the plant products into the shielded treatment area and the field of exposure of the shielded treatment area, optionally hold the plant products within the field of exposure for a predetermined duration of time, and then deliver the plant products from the shielded treatment area. The conveyor system of such a crop treatment apparatus may also transport the irradiated plant products directly into storage or onto an apparatus (e.g., a truck, a trailer, a cart, etc.) for subsequent transportation. As alternatives, the crop treatment apparatus may be capable of irradiating plant products during storage or upon being their removal from storage.

The crop treatment apparatus may have a configuration that enables it to be transported from one location to another to enable its use at a variety of locations (e.g., different harvest, distribution, and/or storage locations, etc.) to irradiate plant products that have been recently removed from the ground. A portable crop treatment apparatus may include a conveyor system and/or shielding. Alternatively, the crop treatment apparatus may be used in conjunction with a separate conveyor system and/or separate shielding at the site of treatment.

A method for treating plant products includes irradiating the plant products. Such a method may include exposing the plant products to a low dose of ionizing radiation at a high dose rate. For example, a low dose of electrons (e.g., about 2.5 kilorads to about 50 kilorads, etc.) may be directed onto the plant products at high speed and at a high dose rate (e.g., about 10⁶ rads per second, greater than about 10⁶ rads per second, etc.). To effectively irradiate substantially all of the surfaces a plant product, the plant product may be rotated with operation of the irradiation element (e.g., electron beam width, raster scanning rate, optional pulsing, etc.) synchronized with the rate at which the plant products rotate to avoid overexposing any portion of the skin or surface of the plant product to the ionizing radiation (e.g., an electron beam, etc.).

Irradiation of the plant products may additionally or alternatively include sanitizing skins or surfaces of the plant products. Sanitization of the skins or surfaces of the plant products may be carried out by exposing the plant products to one or more wavelengths of bandwidths (i.e., ranges of bandwidths) of electromagnetic radiation. Without limitation, exposing the plant products to ultraviolet (UV) radiation (e.g., 10 nm to 400 nm, 100 nm to 280 nm or 185 nm to 254 nm (ultraviolet C or UV-C), 200 nm to 300 nm (middle UV), about 250 nm, 254 nm, etc.) or to high-intensity narrow spectrum (HINS) light (e.g., blue light at a wavelength of about 405 nm, etc.) may kill or otherwise limit the growth and/or proliferation of microorganisms (e.g., bacteria (e.g., bacteria from the genus Erwinia, such as Pectobacterium caratovorum, P. artrosepticum, Dickeya species, which may cause soft rot; etc.), fungi (e.g., silver scurf, or Helminthosporium solani; late blight, or Phytophthora infestans; etc.), fungal spores, other spores, etc.) on the skins or surfaces of the plant products. As relatively long exposure times (e.g., 15 seconds, 30 seconds, 45 seconds, 60 seconds, etc.) may be required to sterilized plant products with UV radiation or HINS light, plant products may be exposed to such sanitizing radiation constantly for a prescribed period of time.

Such a method may be conducted as part of the harvest (e.g., within an hour of harvest, within two hours of harvest, on the day of harvest, within a day after harvest, within two days of harvest, in connection with storage of the plant product, etc.), and may eliminate the need for further treatment or special storage conditions. The plant products may be irradiated when they are delivered from harvest (e.g., by harvesting equipment, etc.) and/or when the plant products are introduced into storage facilities.

The plant products may be conveyed into a shielded treatment area, where, upon entering a field of exposure, they are irradiated. In some embodiments, progress of the plant products may be temporarily delayed (e.g., for a predetermined duration of time, etc.) while they are located within the field of exposure, which may enable the plant products to receive a sufficient dose or a prescribed dose of each type of irradiation. Once the plant products have been irradiated, they may be conveyed out of the field of exposure and out of the shielded treatment area. The plant products may be conveyed directly into storage or to a location (e.g., a truck, a trailer, a cart, etc.) that will facilitate their transport to another location.

In other embodiments, a crop treatment apparatus according to this disclosure may have a configuration that enables it to irradiate plant products as they are harvested and/or collected. As an example, such an embodiment of crop treatment apparatus may have a configuration that enables it to treat plant products while they are collected. For example, the plant products may be received by a conveyer system of the crop treatment apparatus which introduces the plant products into a shielded treatment area where they may be irradiated and conveys them out of the crop treatment apparatus to a collection apparatus (e.g., by a truck, trailer, cart, etc.). Such a crop treatment apparatus may be carried by a harvesting apparatus or by the collection apparatus, or it may comprise physically separate apparatus that travels between the harvester (e.g., the harvesting apparatus, individuals who harvest the plant product, etc.) and the collection apparatus.

A mobile embodiment of a crop treatment apparatus may be capable of moving across the ground (e.g., a field, etc.) in which a crop of food products that grow underground is located and, while moving across the ground, directing ionizing radiation into the ground and into plant products that are located in the ground, or underground. Such a crop treatment apparatus, which may be referred to as a field treatment apparatus, may have a configuration that enables it to be transported over the ground (e.g., over a field in which a crop is grown, etc.) and, while being transported, to irradiate the ground and any plant products that are located just underground (e.g., within about twelve inches of the surface of the ground, within about eight inches of the surface of the ground, within about six inches of the surface of the ground, etc.). The field treatment apparatus may be capable of directing the ionizing radiation onto and into the ground in an unfocussed manner; i.e., over an area of the ground. An irradiating element of the field treatment apparatus may generate radiation and direct that radiation into the ground at a dose and dose rate that will enable the radiation to penetrate into plant products beneath the surface of the ground. In a specific embodiment, the irradiation element may comprise an electron accelerator capable of generating a low dose of high-speed electrons and of directing the electrons into the ground at a high dose rate. Shielding of the field treatment apparatus may provide control over the area of the ground onto and into which the ionizing radiation is directed. In addition, shielding of the field treatment apparatus may limit or prevent exposure of individuals who operate the field treatment apparatus or who are otherwise located in proximity to the apparatus to the ionizing radiation.

Another embodiment of a method for treating plant products comprises irradiating plant products while they remain underground; i.e., before harvesting the plant products. Such a method may include exposing the ground and the plant products in the ground to radiation. Such a process may be conducted as part of the harvest (e.g., within a week prior to harvest, a day before harvest, etc.), and may eliminate the need for further treatment of the plant products once they have been harvested or the need for special storage conditions for the plant products.

Crops that include plant products in the ground whose meristematic cells have been altered or killed but whose non-meristematic cells have not been damaged are also within the scope of this disclosure.

Other aspects of the disclosed subject matter, as well as features and advantages of the disclosed subject matter, will become apparent to those of ordinary skill in the art through consideration of the ensuing description, the accompanying drawings, and the appended claims.

### BRIEF DESCRIPTION OF THE DRAWINGS

In the drawings:

FIG. 1 is a schematic representation of an embodiment of a crop treatment apparatus according to this disclosure;

FIG. 2 is an entry-side view of the embodiment of crop treatment apparatus shown in FIG. 1;

FIG. 3 is an outlet-side view of the embodiment of crop treatment apparatus shown in FIG. 1;

FIG. 4 is a schematic representation of another embodiment of crop treatment apparatus according to this disclosure;

FIG. 5 provides a representation of an embodiment of an apparatus according to this disclosure;

FIG. 6 is a cross-sectional view representation of the apparatus depicted by FIG. 1;

FIG. 7 provides a representation of another embodiment of an apparatus according to this disclosure;

FIG. 8 is a cross-sectional view representation of the apparatus depicted by FIG. 3;

FIG. 9 is a graph depicting an exemplary absorbed dose versus absorbed dose rate operational regime for potatoes in accordance with an embodiment of a method according to this disclosure; and

FIG. 10 is a graph depicting an exemplary absorbed dose versus absorbed dose rate operational regime for sugar beets in accordance with another embodiment of a method according to this disclosure.

### DETAILED DESCRIPTION

According to the law of Bergonié and Tribondeau, the sensitivity of cells to ionizing radiation depends on the number of undifferentiated cells in the tissue, the degree of mitotic activity in the tissue (i.e., the rate at which the cells divide, or replicate or proliferate), and the length of time cells of the tissue proliferate. As a general rule, sensitivity to irradiation is directly correlated to the rate of cell division. In other words, cells that divide more frequently are more sensitive to radiation.

Meristematic cells are undifferentiated plant cells that are responsible for plant growth. It has been found that meristematic cells are more sensitive to radiation than other plant cells. Studies of also shown that sprout inhibition in certain plant products that grow underground may be achieved by inhibiting the cell division of the meristematic cells.

The location of the meristematic cells varies depending on the nature of the plant product. For example, the meristematic cells of a potato may be located in and around the eyes of the potato. The meristematic cells of sugar beets and other vegetables, such as carrots and onions, may be located in and around the crown from which the top growth of the vegetable emerges. Meristematic cells are often located on the surface of the plant product and/or extend inwardly into the volume of the plant product. For example, the meristematic cells of a potato may extend from the skin into the volume of the potato by a distance of as much as half an inch. Generally, non-meristematic cells are located more centrally in the volume of the plant product than the meristematic cells.

The non-meristematic cells of a plant product do not play an active role during sprouting of the plant product. Sprouting may be prevented without exposing non-meristematic cells to radiation. In fact, exposure of the non-meristematic cells to radiation may substantially damage them, resulting in premature decay of the plant product. Specifically, cells that are exposed to large quantities of radiation may die. Once a cell dies, it begins to decay, resulting in damage to the plant product. The plant product may then heal itself, which may consume sugar and speed up decay of the plant product as a whole.

Because of their generally slower growth and replication rates, non-meristematic cells are less sensitive to ionizing irradiation than meristematic cells. Therefore, ionizing radiation may be used to inhibit growth and proliferate of meristematic cells while leaving growth and cell division of the non-meristematic cells unaffected. Since the meristematic cells of the plant product are more sensitive to ionizing radiation (e.g., electrons, etc.) than the non-meristematic cells of the plant product, the dose of ionizing radiation to which a plant product is exposed to prevent sprouting should be sufficiently large to prevent further growth and proliferation of meristematic cells, but low enough so as to avoid damaging the non-meristematic cells. It has been shown that low doses of ionizing radiation delivered at a high dose rate may inhibit growth and cellular division of the meristematic cells while leaving the non-meristematic cells unaffected. As a non-limiting example, about 3 kilorads to about 10 kilorads or, more broadly, about 2.5 kilorads (0.025 kGy) to about 50 kilorads (0.50 kGy) (e.g., about 0.20 kGy, about 0.25 kGy, about 0.50 kGy, etc.) of ionizing radiation (e.g., electrons, etc.) may be delivered to the plant product at an instantaneous dose rate of at least 10⁶ rads per second. Such a dosage and dosage rate may penetrate the skin and surface of a plant product down to its vascular ring (e.g., to a depth of about 0.04 inch, or about 1 mm, to about ¼ inch, or about 6.25 mm, etc.), which may expose meristematic cells of the plant product to radiation without affecting other parts of the plant product. When exposed to ionizing radiation in this manner, the meristematic cells of a plant product may no longer divide, while the non-meristematic cells of such a plant product may remain relatively undamaged. Irradiation of a plant product in this manner may prevent sprouting, greening, and bruising of the plant product, and kill any nematodes present under the skin or below the surface of the plant product.

Values for high-speed electron radiation dosage rates are provided as instantaneous dosage rates, not time-averaged dosage rates. Values for high-speed electron radiation delivered in pulses are provided as pulsed instantaneous dosage rates. As a non-limiting example, the pulse rate may include about one microsecond at frequencies from 100 hertz (Hz) to 300 Hz with various current pulse amplitudes on the order of about 0.1 ampere (A). Alternatively, the pulse rate may range from a tenth of a microsecond to several microseconds. As another alternative, the pulse rate may range from 30 Hz to 500 Hz. In yet another alternative, the current pulse amplitude may range from 10 mA to 40 mA. While examples of suitable pulse durations, pulse rates, and pulse amplitudes have been provided herein, it is apparent to one of ordinary skill in the art that alternate parameters may be used to deliver the desired dose at the desired dose rate.

FIG. 1 depicts an embodiment of a crop treatment apparatus 10. The crop treatment apparatus 10 includes an irradiation element 20, shielding 40, and a conveyor system 60. The irradiation element 20 directs radiation into a field of exposure 25 within a treatment area 45 within the shielding 40. The conveyor system 60 receives food products 1 at a location outside of the shielding 40, transports the food products 1 through an entry 42 of the shielding 40, into and through the field of exposure 25 within the treatment area 45 within the shielding 40, and out of an outlet 48 of the shielding 40.

The irradiation element 20 may comprise a source of ionizing radiation, such as an electron accelerator of a type known in the art. When an electron accelerator is employed as the irradiation element 20, it may be capable of generating and delivering about 2.5 kilorads to about 10 kilorads or, more broadly, about 2.5 kilorads to about 50 kilorads of ionizing radiation (e.g., electrons, etc.) to plant products. The radiation may be delivered in short pulses (e.g., over a fraction of a second) at an instantaneous dose rate of at least 10⁶ rads per second. As a non-limiting example, such an irradiation element 20 may comprise a high power (up to 7.5 MeV) electron accelerator. More specifically, the irradiation element 20 may comprise a 1 MeV to 3 MeV linear accelerator. Other types of electron accelerators (e.g., a Dynamitrons particle accelerator, a Van de Graaff generator, etc.) may also be used as the irradiation element 20 of a crop treatment apparatus according to this disclosure. In embodiments where the irradiation element 20 generates an electron beam, the electron beam may be directed onto the field of exposure 25 as a continuous series of parallel lines (i.e., in a raster pattern) to spread the electrons over the field of exposure 25.

Alternatively, the irradiation element 20 may comprise a source of sanitizing radiation. More specifically, the irradiation element 20 may comprise a source of electromagnetic radiation that is capable of sanitizing a skin or a surface of the food product 1. Such an irradiation element 20 may emit unfocused, or diffused, electromagnetic radiation or it may emit focused electromagnetic radiation (e.g., a collimated beam, a laser beam, etc.). Without limitation, such an irradiation element 20 may generate and deliver ultraviolet (UV) radiation (e.g., 10 nm to 400 nm, 100 nm to 280 nm or 185 nm to 254 nm (ultraviolet C or UV-C), 200 nm to 300 nm (middle UV), about 250 nm, 254 nm, etc.) at an intensity that may kill or otherwise limit the growth and/or proliferation of microorganisms (e.g., bacteria (e.g., bacteria from the genus Erwinia, such as Pectobacterium caratovorum, P. artrosepticum, Dickeya species, which may cause soft rot; etc.), fungi (e.g., silver scurf, or Helminthosporium solani; late blight, or Phytophthora infestans; etc.), fungal spores, other spores, etc.) on the plant products 1. As another example, such an irradiation element 20 may generate blue light (e.g., at a wavelength of about 405 nm, etc.) at an intensity that may kill or otherwise limit the growth and/or proliferation of microorganisms on the plant products 1 (e.g., the irradiation element 20 may comprise a high-intensity narrow spectrum (HINS) light, etc.). Embodiments of irradiation elements 20 that generate and deliver sanitizing wavelengths of electromagnetic radiation may direct the electromagnetic radiation toward the food products 1 at a plurality of angles to enable the electromagnetic radiation to reach microorganisms located within any cuts that are formed in the skins or surfaces of the plant products 1 as they are harvested or transported to the crop treatment apparatus 10.

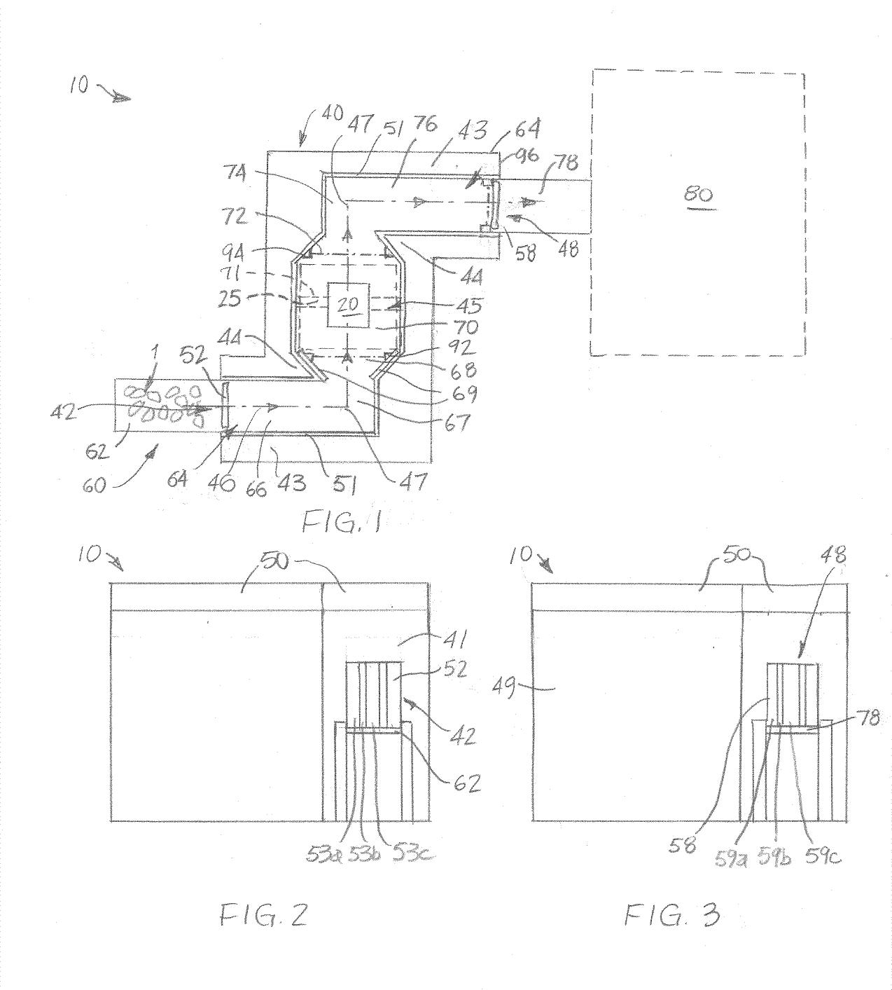

The irradiation element 20 may be housed in the shielding 40 of the crop treatment apparatus 10. The shielding 40 may substantially enclose or totally enclose the irradiation element 20, or at least prevent radiation generated and delivered by the irradiation element 20 from reaching individuals outside of the shielding 40. The shielding 40 may comprise any suitable radiation attenuating material (e.g., concrete, steel, lead (Pb), tungsten (W), etc.) or a combination of radiation attenuating materials. As a nonlimiting example, where the irradiation element 20 generates ionizing radiation, the shielding 40 may comprise a bunker with exterior walls 43 and interior walls 44 formed from concrete having a thickness of at least about 6 inches, or 15.25 cm (e.g., about 8 inches, or about 20 cm; about 12 inches, or about 30 cm; about 24 inches, or about 60 cm; about 48 inches, or about 120 cm; etc). In such embodiments, the exterior walls 43 and any interior walls 44 of the shielding 40 may be constructed from arrays of stacked, interconnected blocks, which may be capable of disassembly to render the shielding 40 and the crop treatment apparatus 10 moveable from one location to another (i.e., portable). A cover 50 (FIGS. 2 and 3) (e.g., a concrete cover, a steel cover, a lead (Pb) cover, a tungsten (W) cover, etc.) may be provided over the tops of the exterior walls 43 and any interior walls 44. Such a bunker may include a lining 51 of a material that further attenuates radiation generated and delivered by the irradiation element 20 (e.g., lead (Pb), tungsten (W), etc.).

With added reference to FIGS. 2 and 3, an entry 42 into the shielding 40 and an outlet 48 from the shielding 40 may comprise openings on different sides (e.g., opposite sides, adjacent sides, etc.) of the shielding 40. As an example, the entry 42 may be located at a front 41 of the shielding 40, while the outlet 48 may be located at a rear 49 of the shielding 40. The locations of the entry 42 and the outlet 48 on the shielding may offset relative to one another.

The entry 42 may be covered with a flexible barrier 52. In some embodiments, the outlet 48 may also be covered with a flexible barrier 58. Each flexible barrier 52, 58 may attenuate or even be impenetrable to radiation generated and delivered by the irradiation element 20. As an example, each flexible barrier 52, 58 may comprise one or more lead (Pb) sheets, which may be lined with rubber and/or a fabric. Each flexible barrier 52, 58 may include a plurality of vertically extending segments 53a, 53b, etc., 59a, 59b, etc., that are arranged horizontally adjacent to one another, and which may partially overlap one another. A weight and a flexibility of the flexible barrier 52 at the entry 42 to the shielding 40 may limit a thickness of a layer of food products 1 passing under the flexible barrier 52 and entering into the shielding 40, for example, to a single layer of the food product 1.

With returned reference to FIG. 1, a path 46 through the shielding 40 may extend from the entry 42, through the treatment area 45 of the shielding 40 in which the field of exposure 25 of the irradiation element 20 is located, to the outlet 48. The path 46 may be nonlinear, requiring the food products 100 to follow an indirect path 46 through the shielding 40. More specifically, the path 46 and the shielding 40 (e.g., interior walls 44 of the shielding 40, etc.) may have configurations that limit the ability of radiation generated and delivered by the irradiation element 20 to reach each opening (i.e., the entry 42 and the outlet 48) of the shielding 40. As such, the path 46 may include one or more bends 47 adjacent to the entry 42 and one or more bends 47 adjacent to the outlet 48.

The conveyor system 60 may include an interior section 64 that follows the path 46 through the shielding 40 (i.e., the conveyor system 60 may be coincident with the path 46). In addition to the interior section 64, the conveyer system 60 may include an entry segment 62, which is also depicted by FIG. 2, and an optional outlet segment 78, which is further depicted by FIG. 3.

The entry segment 62 of the conveyor system 60 has a configuration that enables it to receive bulk quantities of food product 1. The entry segment 62 may be configured to receive the food product 1 from harvesting equipment, from transportation equipment, or the like. The entry segment 62 introduces the food product 1 into the entry 42 of the shielding 40. As an example, the entry segment 62 may comprise a chute oriented at an angle (e.g., a declined angle, etc.) that enables the food product 1 to be fed into the entry 42 by gravity. As another example, the entry segment 62 may comprise a motor-driven conveyer (e.g., a conveyor belt, a series of motor-driven rollers, an array of motor, driven wheels, etc.).

An entry portion 66 of the interior section 64 of the conveyor system 60, which is located on an opposite side of the flexible barrier 52 and the entry 42 from the entry segment 62, may be continuous with the entry segment 62. The entry portion 66 of the interior section 64 receives the food product 1 from the entry segment 64, and conveys the food product 1 to at least one entry bend 67 (e.g., a 90° bend, etc.) in the conveyer system 60. The at least one entry bend 67 may comprise rollers and/or wheels that are capable of continuously conveying the food product 1 as the direction in which the food product 1 is conveyed changes.

The at least one entry bend 67 leads to a widening portion 68 of the interior section 64 of the conveyer system 60. The widening portion 68 enables the food product 1 to spread out and collect as the food product 1 is conveyed to the treatment area 45 and, thus, into the field of exposure 25 of the irradiation element 20. The extent to which the widening portion 68 widens, as well as its length, may slow down the rate at which the food product 1 is conveyed across a treatment portion 70 of the interior section 64 of the conveyer system 60, which may be coincident with the treatment area 45 within the shielding 40 and, thus, within the field of exposure 25 of the irradiation element 20. Thus, the extent to which the widening portion 68 widens and, optionally, its length may determine the duration of time the food product 1 remains within the treatment area 45 and is exposed to radiation from the irradiation element 20. In some embodiments, side rails 69 of the widening portion 68 may be moved, or adjusted, to provide control over the rate at which the food product 1 is conveyed through the treatment area 45, as well as the duration of time the food product 1 resides within the treatment area 45 and the overall dose of radiation the food product 1 receives from the irradiation element 20.

The treatment portion 70 may have a configuration that causes the food product 1 to tumble, or rotate, as the food product 1 is conveyed across the treatment portion 70. For example, and not by way of limitation, the treatment portion 70 may comprise a series of rollers that are spaced apart from one another a sufficient distance to enable the food product 1 to tumble, or rotate. Some of the rollers (e.g., every other roller, etc.) may resist rotation, be rotationally fixed (i.e., it may not rotate), or be rotationally driven to oppose the direction in which the food product 1 is conveyed across the treatment portion 70. Tumbling of the food product 1 may extend the duration of time the food product 1 resides within the treatment area 45 and may enable substantially consistent irradiation of the food product 1 over its entire skin or surface.

In some embodiments, the treatment portion 70 of the internal section 64 of the conveyor system 60 may include at least one residency element 71, which may determine the duration of time that food products 1 remain within the field of exposure 25 of the irradiation element 20 and, optionally, how quickly the food products 1 are rotated while they are located within the field of exposure 25. In some embodiments, the residence element 71 may comprise a two or more adjacent rollers of the treatment portion 70, whose rates and directions of rotation may be controlled to ensure that the plant products 1 remain within in the field of exposure 25 for a sufficient period of time to ensure that the plant products 1 receive a sufficient dose of radiation generated and delivered by the irradiation element 20 to provide a desired effect, but that the plant products 1 do not remain within the field of exposure 25 long enough to receive a potentially damaging dose of radiation.

While the plant products 1 are located on the residency element 71, they may be rotated and, while rotated, each portion of the skin or surface of each plant product may be exposed to electrons or other ionizing radiation at a high dose rate (e.g., at least about 10⁶ rads per second to provide that portion of the skin or surface with a dose of about 0.20 Gy to about 0.50 Gy of the ionizing radiation, etc.). To effectively irradiate substantially all of the surfaces a plant product, the plant product may be rotated with operation of the irradiation element (e.g., electron beam width, raster scanning rate, optional pulsing, etc.) synchronized with the rate at which the plant products rotate to avoid overexposing any portion of the skin or surface of the plant product to the ionizing radiation (e.g., an electron beam, etc.).

Irradiation of the plant products 1 within sanitizing radiation (e.g., UV-C, HINS light, etc.) may be constant, repeatedly exposing all of the surfaces of the plant products 1 as they are conveyed by the treatment portion 70 of the internal section 66 of the conveyor system 60.

From the treatment portion 70, the food product 1 may be conveyed to a narrowing portion 72 of the internal section 64 of the conveyor system 60, to at least one outlet bend 74 of the internal section 64 of the conveyor system 60, and to an outlet portion 76 of the internal section 64 of the conveyor system 60. From the outlet portion 76, the food product 1 may exit the shielding 40 through the outlet 48 and through the flexible barrier 58, if any. The food product 1 may then be further conveyed by an outlet segment 78 of the conveyor system 60. In embodiments where the crop treatment apparatus 10 has been temporarily set up (e.g., transported, assembled, etc.) adjacent to a cellar or other storage 80, the outlet segment 78 may convey the food product 1 directly into the storage 80. Alternatively, the outlet segment 78 may convey the food product 1 into packaging (e.g., 50 lb./25 kg boxes, etc.) or onto transportation equipment (e.g., a truck, a trailer, a cart, etc.).

The various components of the conveyor system 60, or at least portions thereof (e.g., inlet bend 67, widening portion 68, treatment portion 70, narrowing portion 72, outlet bend 74, etc.) that will be exposed to radiation from the irradiation element 20, may be formed from materials that will withstand repeated irradiation. As an example, the components of the conveyor system 60 may be formed from steel, stainless steel, aluminum, or the like. In some embodiments, all of the components of the interior section 64 of the conveyor system may comprise, consist essentially of, or consist of one or more materials that will maintain their structural integrity when repeatedly irradiated by radiation generated and delivered by the irradiation element 20.

Operation of the crop treatment apparatus 10 may be controlled manually. For example, one or more manually operable switches 90 may control operation of the conveyor system 60 and the irradiation element 20.

Alternatively, operation of the crop treatment apparatus 10 may be automatic. As an example, the crop treatment apparatus 10 may include a sensor 92 that detects the presence of food products 1 on a corresponding segment or portion of the conveyor system 60 and, upon detecting the food products 1, initiates operation of motor-driven segment or portions of the conveyor system 60 and operation of the irradiation element 20 (it should be noted that the irradiation element 20 may already be powered on by this point, and that actuation of the irradiation element 20 refers to causing the irradiation element 20 to generate and deliver radiation). Additionally, the crop treatment apparatus 10 may include a sensor 94 that detects the absence of food products 1 on a corresponding segment or portion of the conveyor system 60 and, upon determining that no additional food products 1 will pass that sensor 94, begins shutting down operation of the irradiation element 20 and, optionally, the conveyor system 60. For example, upon detecting the absence of food products 1, the sensor 94 may initiate a timed sequence in which the irradiation element 20 and/or the conveyor system 60 are to be shut down, such as a time at which all remaining food products 1 on the conveyor system 60 have passed beyond or are expected to pass beyond the treatment portion 70 of the internal section 64 of the conveyor system 60 and a time at which all remaining food products 1 on the conveyor system 60 have been delivered or are expected to be delivered by the outlet segment 78 of the conveyor system 60.

In a specific embodiment, a first sensor 92 (e.g., a laser sensor, etc.) may detect food product 1 as it is conveyed by the widening portion 68 of the internal section 64 of the conveyor system 60 to the treatment portion 70 of the internal section 64 of the conveyor system 60 and, upon detecting the presence of food product 1, actuates one or more motors that drive various components of the conveyor system 60, as well as the irradiation element 20 (it should be noted that the irradiation element 20 may already be powered on by this point, and that actuation of the irradiation element 20 refers to causing the irradiation element 20 to generate and deliver radiation). A second sensor 94 (e.g., a laser sensor, etc.) may be located on the opposite side of the treatment portion 70, at an entrance to the narrowing portion 72 of the internal section 64 of the conveyor system 60. Once both the first sensor 92 and the second sensor 94 no longer detect food product 1, operation of the irradiation element 20 may terminate, and continued operation of the conveyor system 60 may be contingent upon the passage of a predetermined amount of time (e.g., a duration of time at which all further food product 1 is expected to have been delivered by the outlet segment 78 of the conveyor system 60, etc.) or until the passage of food product 1 is no longer detected past a third sensor 96 (e.g., a laser sensor, etc.) associated with the outlet segment 78.

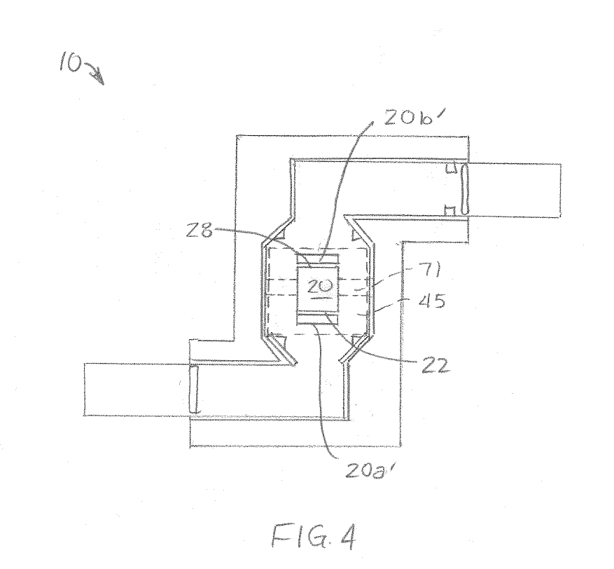

Turning now to FIG. 4, another embodiment of crop treatment apparatus 10′ according to this disclosure is depicted. That embodiment of crop treatment apparatus 10′ includes a primary irradiation element 20 that comprises an electron accelerator, as well as all of the features of the embodiment of crop treatment apparatus 10 illustrated by and described in reference to FIGS. 1-3. In addition the embodiment of crop treatment apparatus 10″ depicted by FIG. 4 includes one or more ancillary irradiation elements 20a′, 20b′, etc. More specifically, a first ancillary irradiation element 20a′, which may comprise a source of sanitizing radiation (e.g., high intensity UV-C radiation, HINS light, etc.) may be positioned adjacent to an entry side 22 of the primary irradiation element 20, while a second irradiation element 20b′ may be positioned adjacent to an exit side 28 of the primary irradiation element 20. Such an arrangement of the primary irradiation element 20 and the ancillary irradiation elements 20a′, 20b′ may enable the crop treatment apparatus 10′ to concurrently sanitize and prevent sprouting and growth of food products 1 as they are stored.

In embodiments where the crop treatment apparatus 10′ includes a primary irradiation element 20 that comprises an electron accelerator and ancillary irradiation elements 20a′ and 20b′ that comprise sources of sanitizing radiation, operation of the primary irradiation element 20 (e.g., electron beam width, raster scanning rate, optional pulsing, etc.) and, thus, the manner in which electrons are directed toward the residency element 71 of the treatment portion 70 of the internal section 64 of the conveyor system 60 may be synchronized with the rate at which the plant products rotate to avoid overexposing any portion of the skin or surface of the plant product to the ionizing radiation (e.g., an electron beam, etc.), while the ancillary irradiation elements 20a′ and 20b′ may continuously emit sanitizing radiation over the treatment portion 70 and, thus, over the treatment area 45.

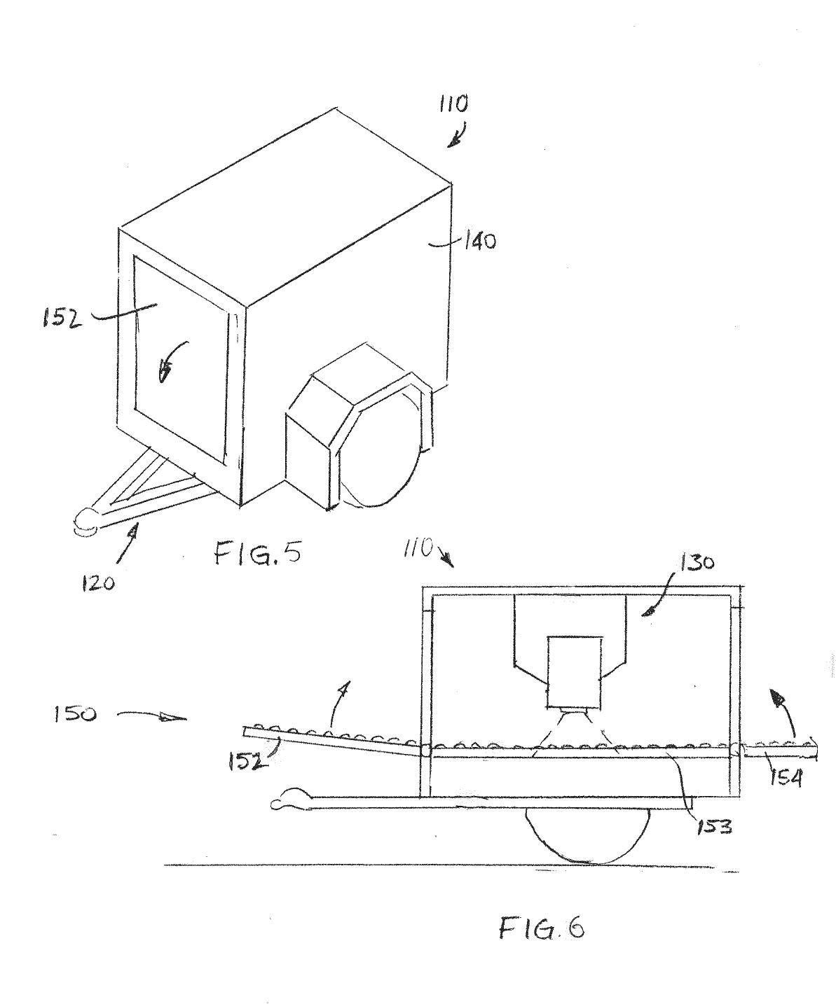

Referring to FIGS. 5 and 6, an embodiment of a mobile crop treatment apparatus 110 is shown. The mobile crop treatment apparatus 110 can be transported from one location to another. It may be used to irradiate plant products at one or more locations to which it is transported and/or the mobile crop treatment apparatus 110 may be used to irradiate plant products while it moves, or is transported. The mobile crop treatment apparatus 110 includes a transport component 120, an irradiation element 130, shielding 140 (which may be optional), and a conveyor 150. The transport component 120 may carry the irradiation element 130, any shielding 140, and the conveyor 150. The shielding 140, if any, may at least partially cover the irradiation element 130.

The transport component 120 may include a chassis, one or more axles, a suspension, and wheels, as well as a towing member that enables towing of the mobile crop treatment apparatus 110. In some embodiments, in place of or in addition to a towing member, the transport component 120 may comprise a drive train (e.g., motor or an engine, a transmission, etc.), steering, and associated components (e.g., a fuel system, a braking system, etc.). As an alternative, the transport component 120 may be carried by harvesting equipment.

The conveyor 150 may enable the introduction of plant products into and through an interior of the mobile crop treatment apparatus 110, and the delivery of irradiated plant products from the mobile crop treatment apparatus 110. As illustrated, the conveyor 150 includes an input element 152, an internal element 153, and a delivery element 154. The input element 152, which may enable the introduction of plant products into an interior of the mobile crop treatment apparatus 110, may be carried by and, optionally, integrated into a door that opens and closes relative to a body of the mobile irradiation apparatus 110. The internal element 153 extends across at least a portion of the interior of the mobile crop treatment apparatus 110 to enable plant products to be transported through the interior of the mobile crop treatment apparatus 110. The delivery element 154 may be carried by and, optionally, integrated into a door in a body of the mobile crop treatment apparatus 110 to enable the delivery of irradiated plant products from the mobile crop treatment apparatus 110. The input element 152, the internal element 153, and the delivery element 154 may comprise any suitable type or types of conveyor elements. As a nonlimiting example, each of the input element 152 and the delivery element 154 may comprise a series of rollers, while the internal element 153 may comprise a motor-driven conveyor belt.

The irradiation element 130 may generate and deliver one or more types of radiation (e.g., ionizing radiation, such as electrons; sanitizing radiation, such as UV-C or HINS light; etc.). The irradiation element 130 may be oriented to direct the radiation across an area on the internal element 153 of the conveyor 150. The irradiation element 130 of the mobile irradiation apparatus 110 may comprise any suitable source of ionizing radiation, such as the irradiation elements 20 described in reference to FIG. 1.

The shielding 140 may have a configuration that limits the escape of radiation from the mobile crop treatment apparatus 110 to locations where plant products are introduced into, carried through, and delivered by the conveyor 150 of the mobile crop treatment apparatus 110. Thus, the shielding 140 may limit the exposure of individuals who operate the mobile crop treatment apparatus 110 or individuals who are working near the mobile crop treatment apparatus 110 during is use to radiation generated and delivered by the irradiation element 130 of the mobile crop treatment apparatus 110.

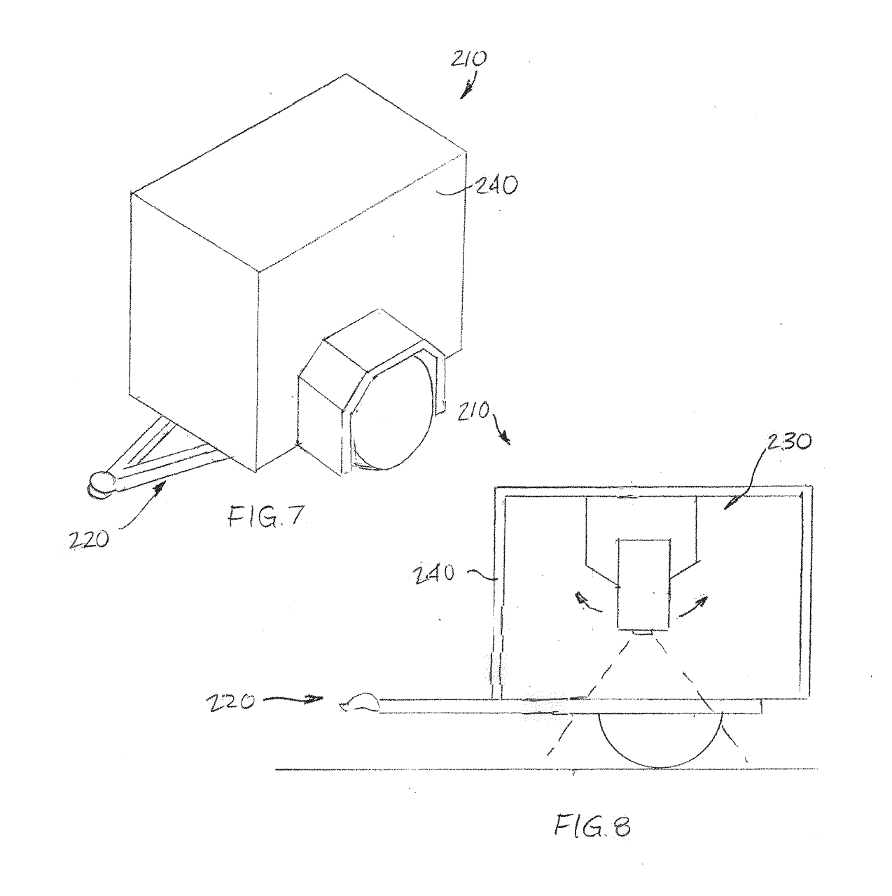

FIGS. 7 and 8 show an embodiment of a mobile crop treatment apparatus 210 that is capable of moving across the ground (e.g., a field, etc.) in which a crop of plant products that grow beneath the surface of the ground is located and, while moving across the ground, irradiating plant products that are located beneath the surface of the ground. The mobile crop treatment apparatus 210 includes a transport component 220, an irradiation element 230, and, optionally, shielding 240. The transport component 220 may carry the irradiation element 230 and any shielding 240. The shielding 240, if any, may at least partially cover the irradiation element 230.

The transport component 220 may include a chassis, one or more axles, a suspension, and wheels, as well as a towing member that enables towing of the mobile crop treatment apparatus 210. In some embodiments, in place of or in addition to a towing member, the transport component 220 may comprise a drive train (e.g., motor or an engine, a transmission, etc.), steering, and associated components (e.g., a fuel system, a braking system, etc.).

The irradiation element 230 may be oriented to direct radiation, such as electrons, across and into (e.g., at least about 7 inches, or about 20 cm, deep; etc.) an area on the ground beneath the mobile crop treatment apparatus 210. The irradiation element 230 of the mobile crop treatment apparatus 210 may comprise any suitable source of ionizing radiation. In some embodiments, the irradiation element 230 may comprise an electron accelerator (e.g., a high-speed electron linear accelerator, etc.).

The shielding 240 may have a configuration that limits the escape of ionizing radiation from the mobile crop treatment apparatus 210 to locations beneath the mobile crop treatment apparatus 210. Thus, the shielding 240 may limit the exposure of individuals who operate the mobile crop treatment apparatus 210 or individuals working near the mobile crop treatment apparatus 210 during is use to ionizing radiation generated by the irradiation element 230 of the mobile crop treatment apparatus 210.

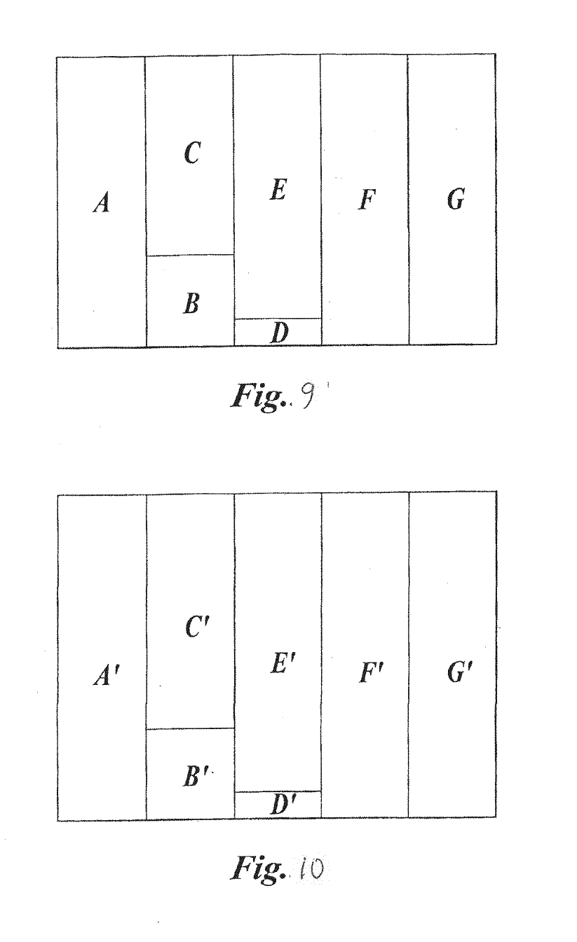

FIG. 9 is a graph of an embodiment of an absorbed dose versus absorbed dose rate operational regime for use in irradiating potatoes in accordance this disclosure. The x-axis of FIG. 9 is the total absorbed dose. The y-axis of FIG. 9 is absorbed dose rate (as mentioned above this value refers to the instantaneous or pulsed instantons dose rate). At very low dose, regardless of the dose rate, no noticeable change is achieved because an insufficient dose was applied to the plant product. Region A designates the region of insufficient absorbed dose. As a non-limiting example, for potatoes, doses below about 2.5 kilorads (0.025 Gy) may be insufficient to prevent sprouting.

Region B designates a region where no noticeable change is achieved because the dose is delivered at too low of a dose rate. The dose level of region B may be effective if delivered at a higher dose rate. The dose range encompassed by region B may include about 2.5 kilorads to about 50 kilorads, and includes dosages of about 3 kilorads to about 10 kilorads, dosages of about 5 kilorads, dosages of about 20 kilorads (0.20 kGy) dosages of about 25 kilorads (0.25 kGy), and dosages of about 50 kilorads (0.50 kGy). Experiments have shown that the upper boundary of Region B (i.e., the dose rate at which the dose levels of Region B become effective) may be approximately 10⁶ rads per second.

If the dose rate is increased to that depicted in region C, cell division of the meristematic cells will be inhibited. It is appreciated by one of ordinary skill in the art that while the border between region B and region C is depicted as a horizontal line, the border between these regions may in fact be non-linear or sloped. Region C may be considered an “operating envelope” where the absorbed dose is delivered at sufficient rate to secure the positive effects of irradiation: cessation of sprouting and greening through the inhibition of meristematic cell division, without the deleterious consequences (i.e., without damaging non-meristematic cells).

Region D depicts the dose rate and dose level typically delivered by a traditional gamma ray (Cobalt-60) system. As discussed above, a gamma ray system may operate at approximately 10,000 rads per minute (6,000 Gray/hour) and deliver around a 20 kilorads dose. Region E represents dose rates too high for a traditional gamma ray system (without adding additional radioactive manner), but within the range achievable by high-speed electron irradiation. Therefore, the operating envelope may also encompass Region E.

Region F represents the dosage at which non-meristematic cells become substantially damaged. As discussed above, in actual application, Region D may extend into this region. Region D may include doses of about 20 to 50 kilorads. Region G represents the circumstance under which the total applied dose is high enough to be capable of sterilizing the product.

The borders between the regions A, B, C, D, E, F, and G may overlap. Further, these regions are depicted in a very simplistic manner for illustrative purposes and are in no way intended to limit the relative shapes, sizes, scopes, or locations of the depicted regions. Further, the regions A, B, C, D, E, F and G may vary depending upon the type of plant product to be treated, as well as a variety of other conditions (e.g., depth, soil content, etc.).

FIG. 10 is a graph of an embodiment of an absorbed dose versus an absorbed dose rate operational regime for sugar beets. This graph, like the graph depicted in FIG. 10, is merely an illustration intended to clarify the principles of this disclosure and is not intended to convey any quantitative information. In FIG. 10, the insufficient absorbed dose region is marked as A′. Doses below about 2.5 kilorads have been shown to be ineffective to inhibit sprouting. The region where no noticeable change is achieved because the dose is delivered at too low of a dose rate is marked B′. The dose range encompassed by Region B′ may be about 2.5 kilorads to about 50 kilorads.

The operational regime for sugar beets is identified as region C′ (as with the FIG. 9, region E′ many also be considered part of the operational regime because the high-speed electron system can operate at these rates). The rate at which region C′ begins is about 10⁶ rads per second. Region C′ may include a dose of about 5 kilorads to about 10 kilorads of ionizing radiation. As discussed with reference to FIG. 9, the border between region B′ and region C′ may not be a horizontal line (or a single dose rate value). Region D′ depicts the dose rate and dose level typically delivered by a traditional gamma ray (Cobalt-60) system. The bounds of region D are generally similar to the bounds discussed with reference to FIG. 9. Region F′ represents the dosage at which non-meristematic cells become substantially damaged. In sugar beets, the non-meristematic cells become substantially damaged at approximately 20 kilorads to about 50 kilorads. Sterilization occurs in region G′. Sterilization, in this case, occurs at the same dose used to sterilize potatoes in FIG. 9.

The operational regime for sugar beets, in region C′ of FIG. 10, may be different from the operational regime of region C in FIG. 9 for potatoes. Similarly, other plant products may also have different operational regimes.

The methods of this disclosure have many practical commercial applications. For example, instead of being crowned, sugar beets may be irradiated. Irradiation of potatoes may provide a faster, cost effective way of preventing sprouting. Other vegetables, such as onions, carrots, garlic, parsnips, and rutabagas may also benefit for treatment by the present method.

Another aspect of this invention includes applying the method of the present invention to inhibit greening in potatoes. Potatoes green when exposed to sunlight, causing them to taste bitter. Generally, greening is avoided during storage by reducing exposure to sunlight. Stores that display potatoes on the shelves expose them to sunlight, often causing greening before the potatoes are sold. Exposing the potatoes to low dosages of irradiation delivered at a high instantaneous dose rates may delay greening by about 2 weeks to as long as three months.

The preceding specification provides a description of some specific embodiments of the disclosed subject matter. It should not be considered in such a way as to limit the scope of any of the claims that follow. Each claim should be construed in a manner consistent with its plain language, and encompass all equivalents to each of its elements.

What is claimed:

1. A method for inhibiting the sprouting of a plant product, comprising:
introducing the plant product onto a conveyor system;
conveying the plant product into shielding;
conveying the plant product over a nonlinear path through the shielding, including conveying the plant product past ionizing radiation within the shielding to expose the plant product to the ionizing radiation within the shielding;
while conveying the plant product past the ionizing radiation, causing the plant product to tumble or roll; and
conveying the plant product out of the shielding, directly into packaging or storage.

2. The method of claim 1, further comprising:
temporarily setting up the conveyor system, the shielding, and a source of the ionizing radiation at a packaging location or a storage location.

3. The method of claim 2, further comprising:
disassembling the shielding, the conveyor system, and the source of the ionizing radiation for transportation to another location.

4. The method of claim 1, wherein conveying the plant product past the ionizing radiation comprises limiting exposure of the plant product to the ionizing radiation to an amount that will inhibit sprouting and/or growth of the plant product without damaging the food product.

5. The method of claim 1, further comprising:
conveying the plant product through sanitizing radiation while causing the plant product to tumble or roll.

6. The method of claim 5, wherein conveying the plant product through the sanitizing radiation comprises killing microorganisms on the plant product.

7. The method of claim 1, wherein conveying the plant product past ionizing radiation comprises inhibiting cell division in meristematic cells of the plant product.

8. A crop treatment apparatus, comprising:
shielding including a first side with an entry, a second side with an outlet, an a non-linear path between the entry and the outlet;
a conveyor system including an entry portion, an entry bend, a widening portion, a treatment portion, a narrowing portion, an outlet bend, and an outlet portion positioned along the non-linear path; and
at least one irradiation element capable of generating radiation and directing the radiation over a field of exposure coincident with at least a portion of the treatment portion of the conveyor system.

9. The crop treatment apparatus of claim 8, further comprising:
a flexible barrier located over the entry in the first side of the shielding.

10. The crop treatment apparatus of claim 8, wherein the widening portion of the conveyor system includes adjustable side rails.

11. The crop treatment apparatus of claim 8, wherein the at least one radiation element comprises an electron accelerator.

12. The crop treatment apparatus of claim 11, wherein the treatment portion of the conveyor system includes a residency element that controls an amount of time a food product is exposed to ionizing radiation generated and delivered by the at least one irradiation element.

13. The crop treatment apparatus of claim 11, wherein the at least one radiation element further comprises a source of sanitizing radiation.

14. The crop treatment apparatus of claim 13, wherein the source of sanitizing radiation generates and delivers ultraviolet C radiation and/or HINS light.

15. The crop treatment apparatus of claim 8, wherein the at least one radiation element comprises a source of sanitizing radiation.

16. A mobile irradiating apparatus, comprising:
a transport component capable of enabling transportation of the mobile irradiating apparatus over a surface of the ground; and
a source of ionizing radiation carried by the transport component and capable of directing ionizing radiation into the ground beneath the transport component during transportation of the mobile irradiating apparatus over the surface of the ground in a manner capable of preventing growth and/or replication of meristematic cells of plant products beneath the surface of the ground without substantially preventing growth and/or replication of non-meristematic cells of the plant products beneath the surface of the ground.

17. The mobile irradiating apparatus of claim 16, wherein the source of ionizing radiation comprises an electron accelerator.

18. The mobile irradiating apparatus of claim 16, wherein the electron accelerator is capable of directing a dose of about 3 kilorads to about 10 kilorads to the ground at a rate of at least about 10⁶ rads per second.
